(19) United States
(12) Patent Application Publication
(10) Pub. No.: US 2018/0373884 A1
(43) Pub. Date: Dec. 27, 2018

(54) METHOD OF PROVIDING CONTENTS, PROGRAM FOR EXECUTING THE METHOD ON COMPUTER, AND APPARATUS FOR PROVIDING THE CONTENTS

(71) Applicant: COLOPL, Inc., Tokyo (JP)

(72) Inventors: Yuta INOUE, Tokyo (JP); Kenzo EBINA, Tokyo (JP); Seiji SATAKE, Tokyo (JP)

(21) Appl. No.: 16/012,806

(22) Filed: Jun. 20, 2018

(30) Foreign Application Priority Data
Jun. 21, 2017 (JP) 2017-121217

(51) Int. Cl. G06F 21/62; G06F 3/147; G06F 3/14; G06Q 30/02

(52) U.S. Cl. CPC G06F 21/62; G06Q 30/0269; G06F 3/1454; G06F 3/147

(57) ABSTRACT

A method of providing content according to at least one embodiment of this disclosure includes acquiring first information from an article, wherein the first information identifies first content data to be managed by a server. The method further includes acquiring second information from the article, wherein the second information is used for authentication that an access request to the first content data is valid. The method further includes transmitting the access request including the first information and the second information to the server. The method further includes receiving the first content data from the server, wherein the first content data is transmitted from the server in response to the server authenticating that the access request is valid by using the second information. The method further includes outputting to a head-mounted device (HMD) a visual-field image that is based on the first content data.

### TECHNICAL FIELD

This disclosure relates to a technology for providing content, and more particularly, to a technology for providing content via a virtual reality space.

### BACKGROUND

Regarding provision of content, there is known a method in which content is stored on a compact disc (CD), a digital versatile disc (DVD), or other recording medium, and the medium is provided. There is also known a technology in which content data is distributed by streaming. Recently, there has also been known a technology for providing content (hereinafter also referred to as “virtual reality (VR) content”) in a virtual reality space (also referred to as “virtual space”). When the content to be provided is digital data, there are problems such as copying and unauthorized use. To address such problems, for example, in Japanese Patent Application Laid-open No. 2003-187524 (Patent Document 1), there is described a technology for “providing a rental business system capable of preventing unauthorized use of information that is recorded on a computer recording medium and is capable of being played back, such as music and images, protecting the recorded information, and controlling rental conditions” (see “Abstract”).

### PATENT DOCUMENT

[Patent Document 1] JP 2003-187524 A

### SUMMARY

According to at least one embodiment of this disclosure, there is provided a method of providing content including: acquiring first information from an article, the first information identifying first content data to be managed by a server; acquiring second information from the article, the second information being used for authentication that an access request to the first content data is valid; transmitting the access request including the first information and the second information to the server; receiving the first content data from the server, the first content data being transmitted from the server in response to the server authenticating that the access request is valid by using the second information; and outputting to a head-mounted device (HMD) a visual-field image that is based on the first content data.

The above-mentioned and other objects, features, aspects, and advantages of this disclosure may be made clear from the following detailed description of this disclosure, which is to be understood in association with the attached drawings.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of a hardware configuration of a smartphone 1480 according to at least one embodiment of this disclosure.

FIG. 15A A diagram of a transition of a screen displayed on a monitor 1463 according to at least one embodiment of this disclosure.

FIG. 15B A diagram of a transition of the screen displayed on the monitor 1463 according to at least one embodiment of this disclosure.

FIG. 15C A diagram of a transition of the screen displayed on the monitor 1463 according to at least one embodiment of this disclosure.

FIG. 15D A diagram of a transition of the screen displayed on the monitor 1463 according to at least one embodiment of this disclosure.

FIG. 15E A diagram of a transition of the screen displayed on the monitor 1463 according to at least one embodiment of this disclosure.

FIG. 16 A schematic diagram of a configuration of an HMD system 100 according to at least one embodiment of this disclosure.

FIG. 17 A diagram of motion performed by an HMD 120 when a user 5 enjoys VR content according to at least one embodiment of this disclosure.

FIG. 18 A block diagram of a detailed configuration of modules of a computer according to at least one embodiment of this disclosure.

FIG. 19 A schematic diagram of one mode of storage of data in a storage 630 included in a server 600 according to at least one embodiment of this disclosure.

FIG. 20 A flowchart of a portion of processing to be executed by the smartphone 1480 mounted to the HMD 120 according to at least one embodiment of this disclosure.

FIG. 21 A flowchart of an example of a portion of processing to be executed by the smartphone 1480 to display an image photographed during playback of the VR content according to at least one embodiment of this disclosure.

FIG. 22 A diagram of a screen displayed on a display 430 installed in a shop according to at least one embodiment of this disclosure.

FIG. 23A A diagram of a transition of the screen displayed on the monitor 1463 of the smartphone 1480 according to at least one embodiment of this disclosure.

FIG. 23B A diagram of a transition of the screen displayed on the monitor 1463 of the smartphone 1480 according to at least one embodiment of this disclosure.

FIG. 23C A diagram of a transition of the screen displayed on the monitor 1463 of the smartphone 1480 according to at least one embodiment of this disclosure.

FIG. 24 A schematic diagram of a configuration of the HMD system 100 according to at least one embodiment of this disclosure.

FIG. 25 A diagram of one mode of storage of data in the storage 630 included in the server 600 according to at least one embodiment of this disclosure.

FIG. 26 A flowchart of a flow of procedures to be executed by the user 5 according to at least one embodiment of this disclosure.

FIG. 27 A flowchart of a portion of processing to be executed by the HMD system 100 according to at least one embodiment of this disclosure.

FIG. 28 A diagram of one mode of the screen displayed by the display 430 to notify of a waiting order situation according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

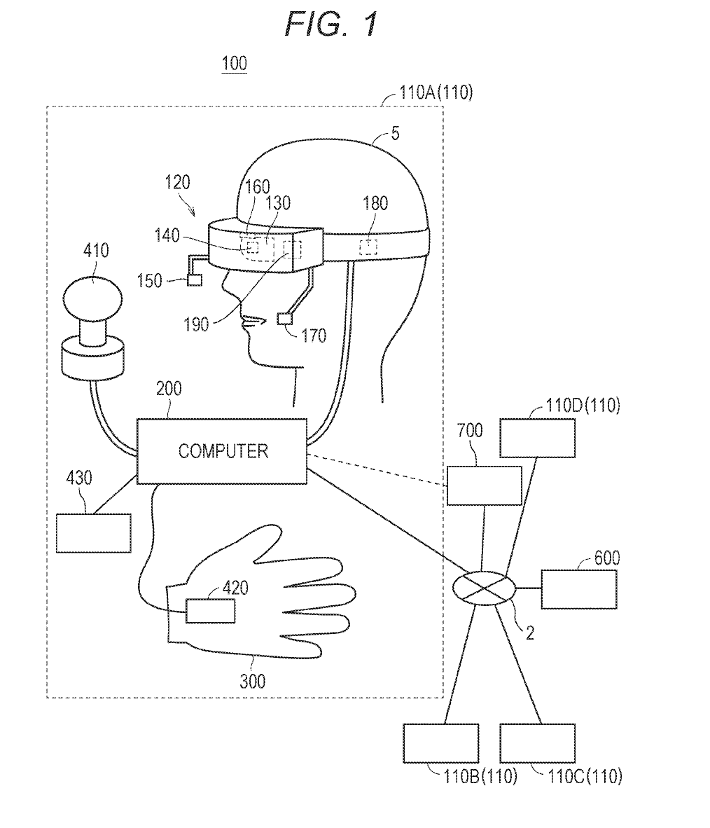

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

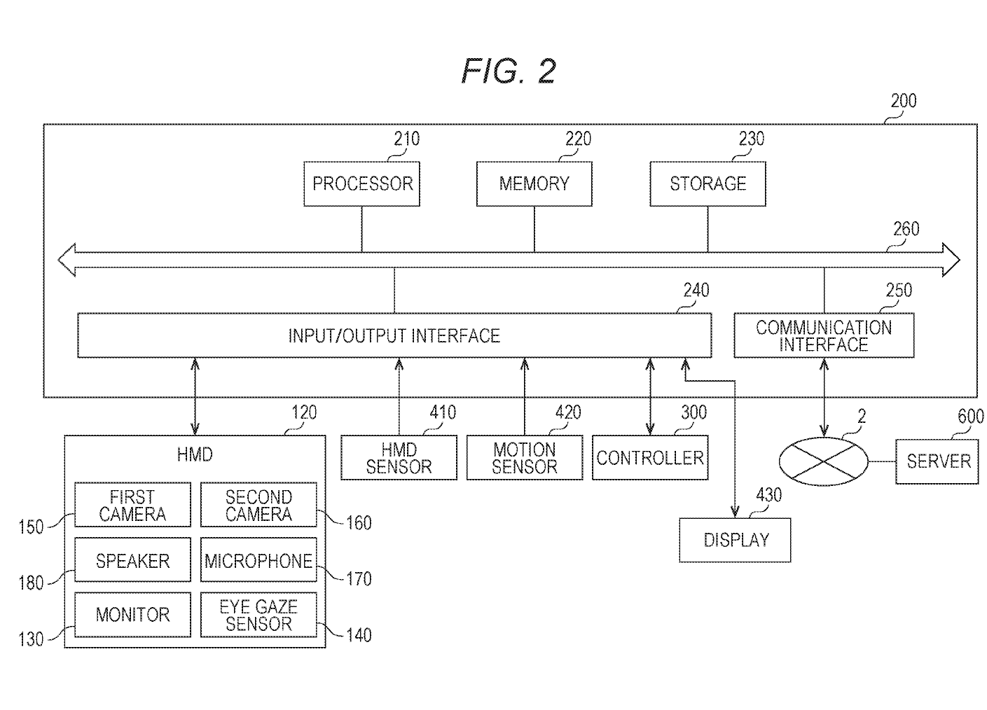

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth (R), near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

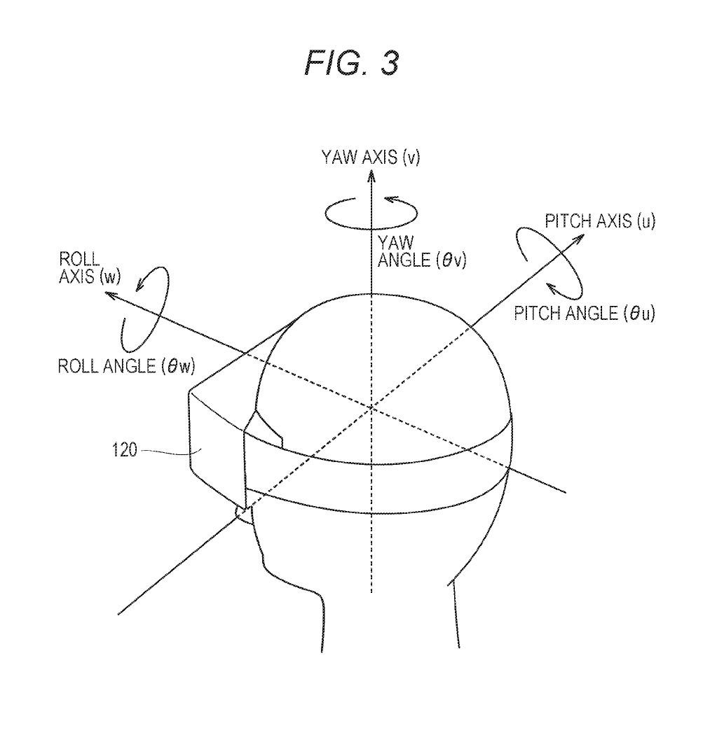

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

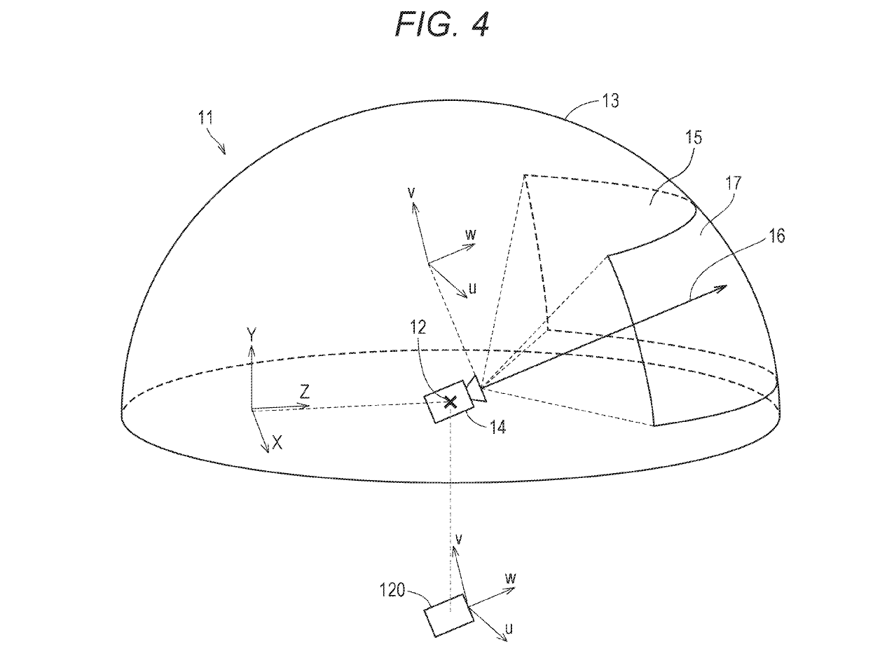

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

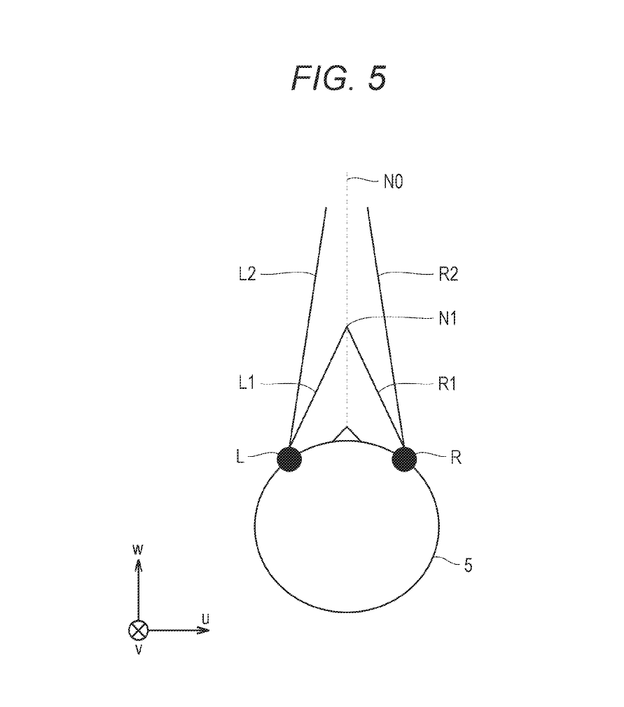

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight NO of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight NO. The line of sight NO is a direction in which the user 5 actually directs his or her lines of sight with both eyes. The line of sight N0 corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-Of-View Region]

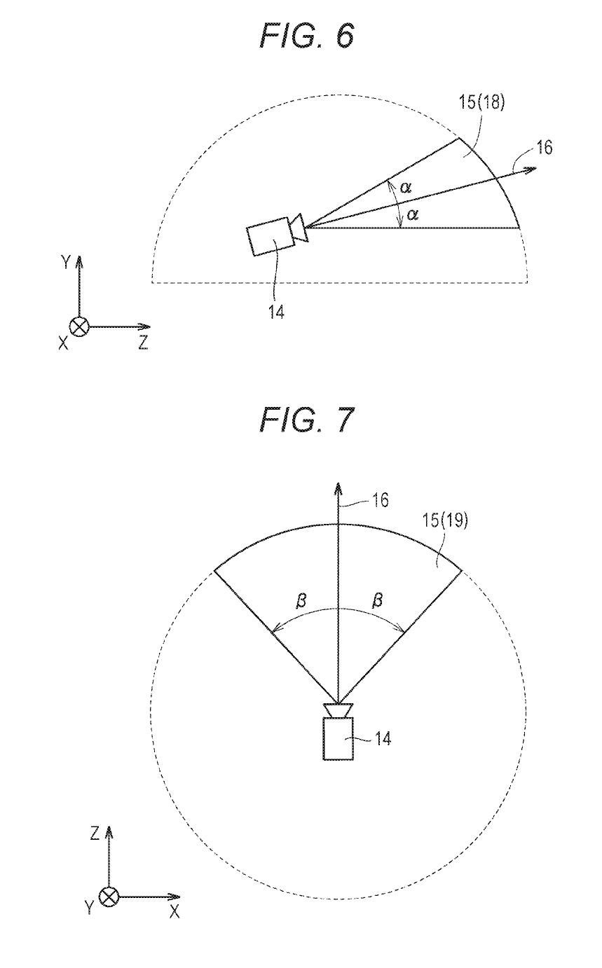

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to apart of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

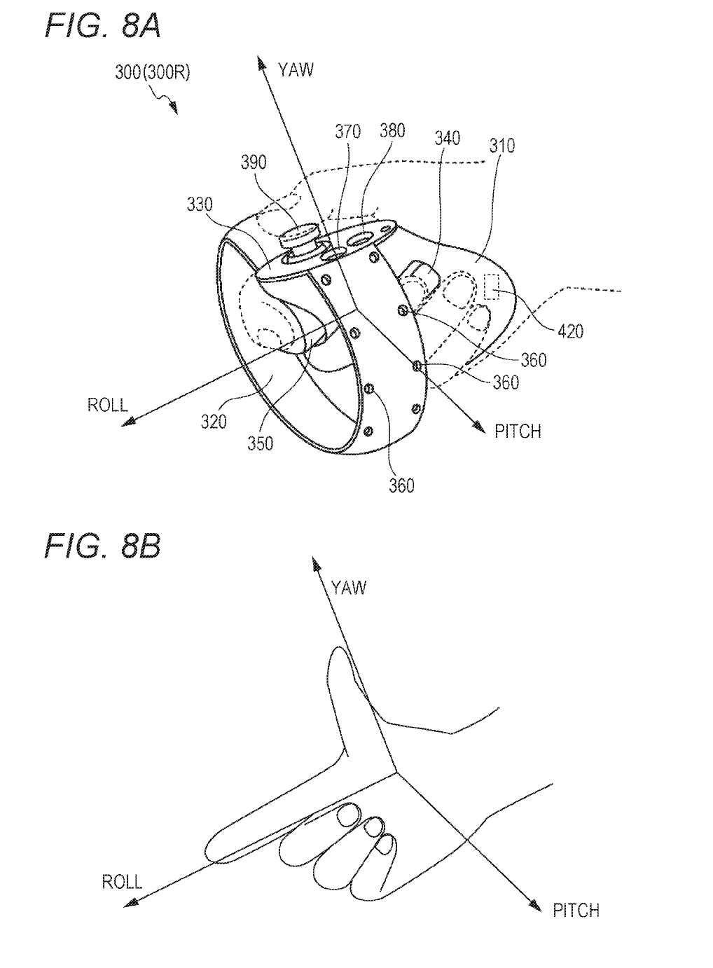

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

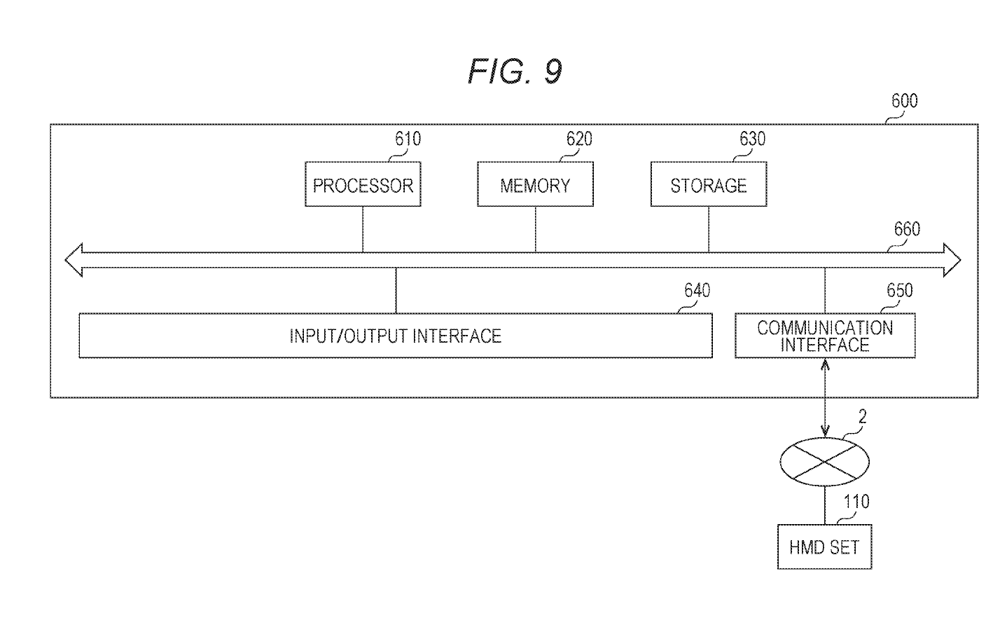

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

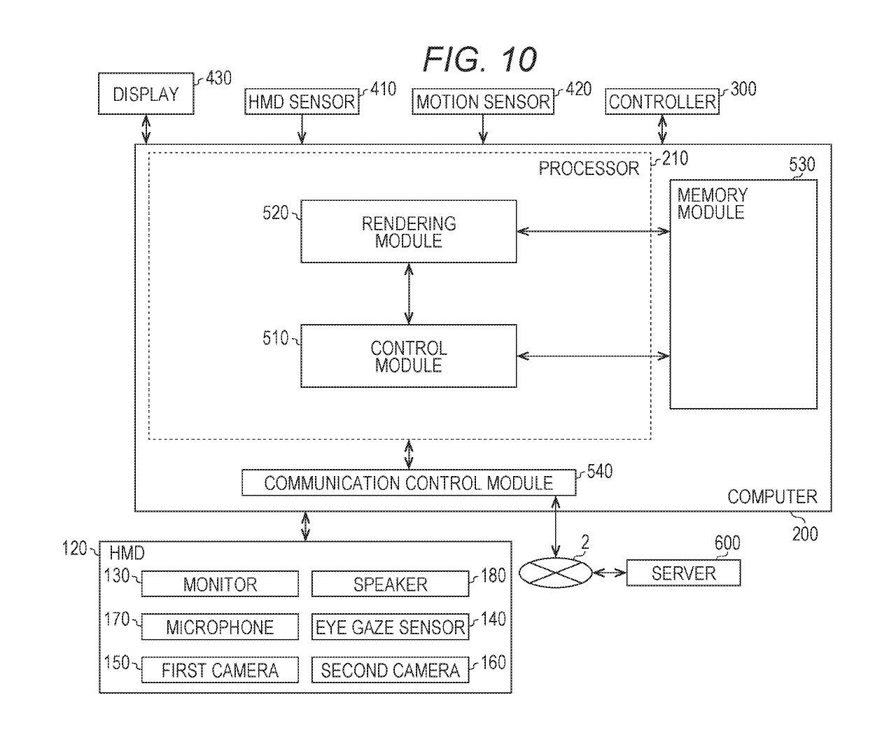

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity (R) provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

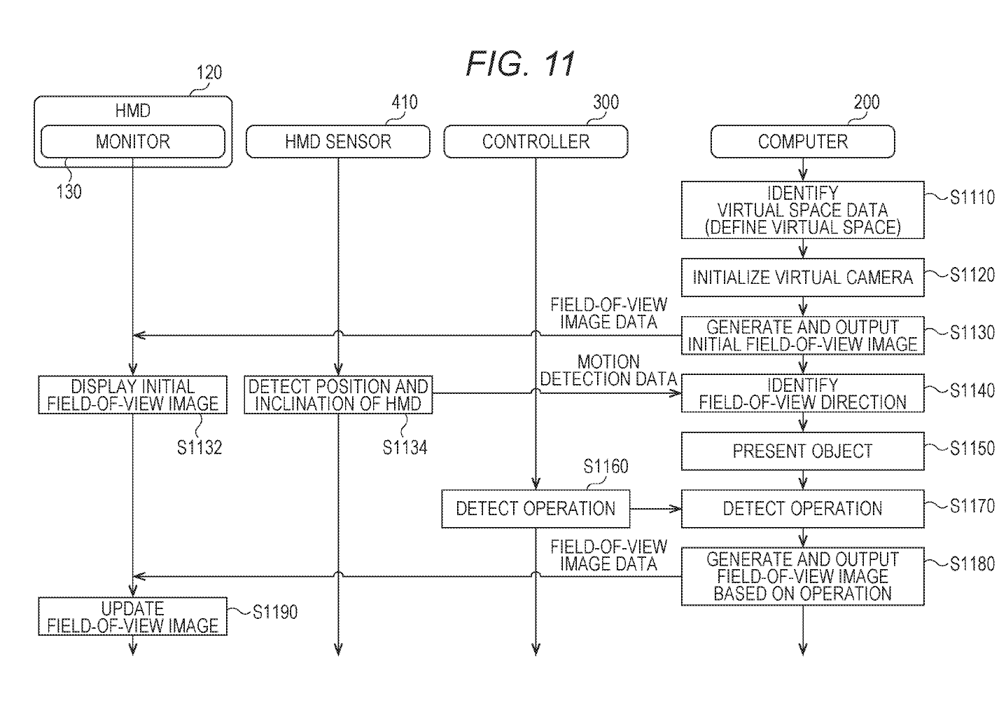

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5.

The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

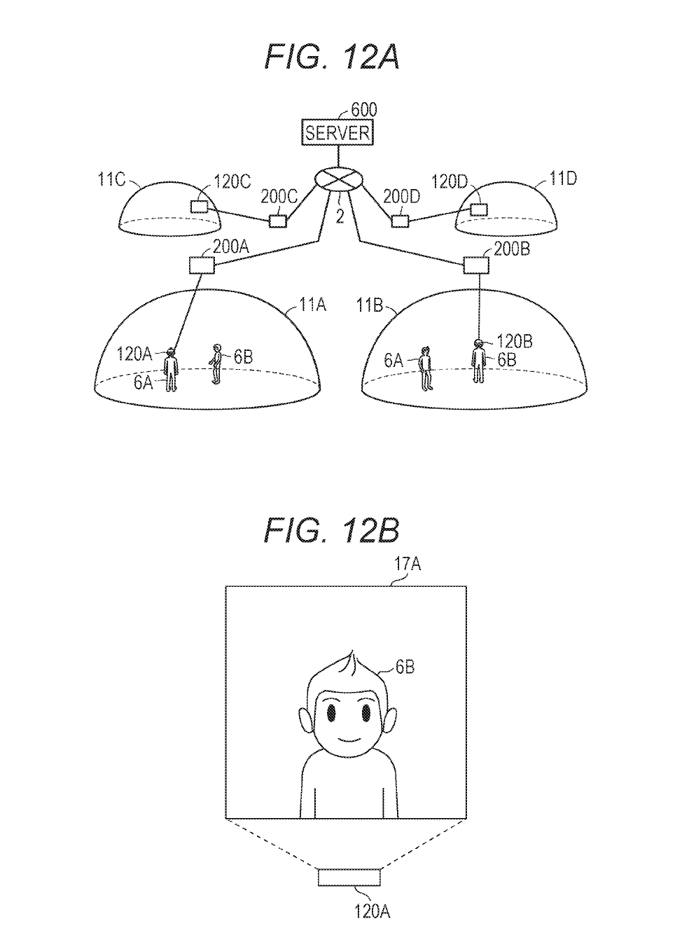

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

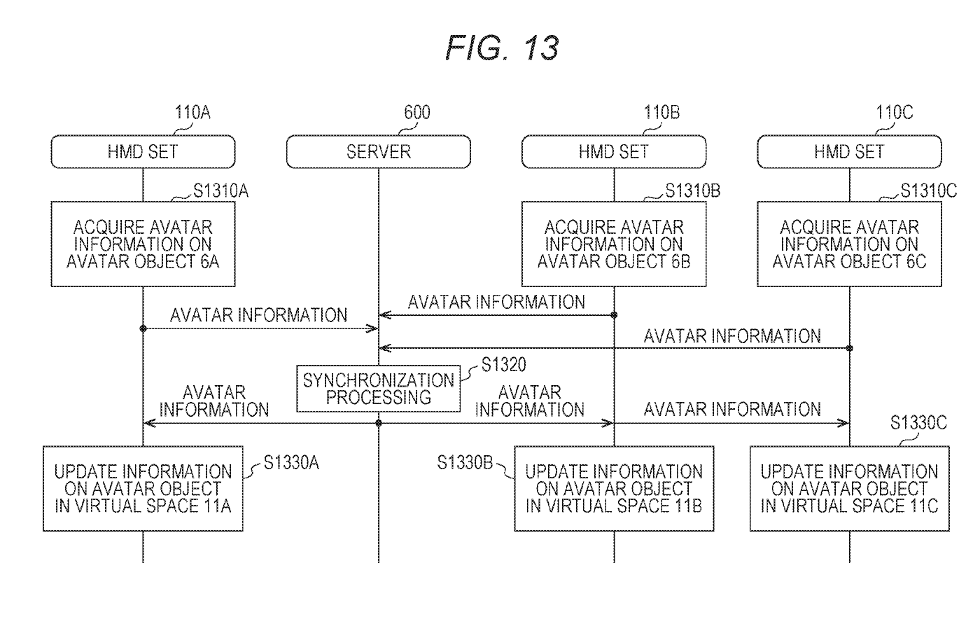

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

### [Configuration of Smartphone 1480]

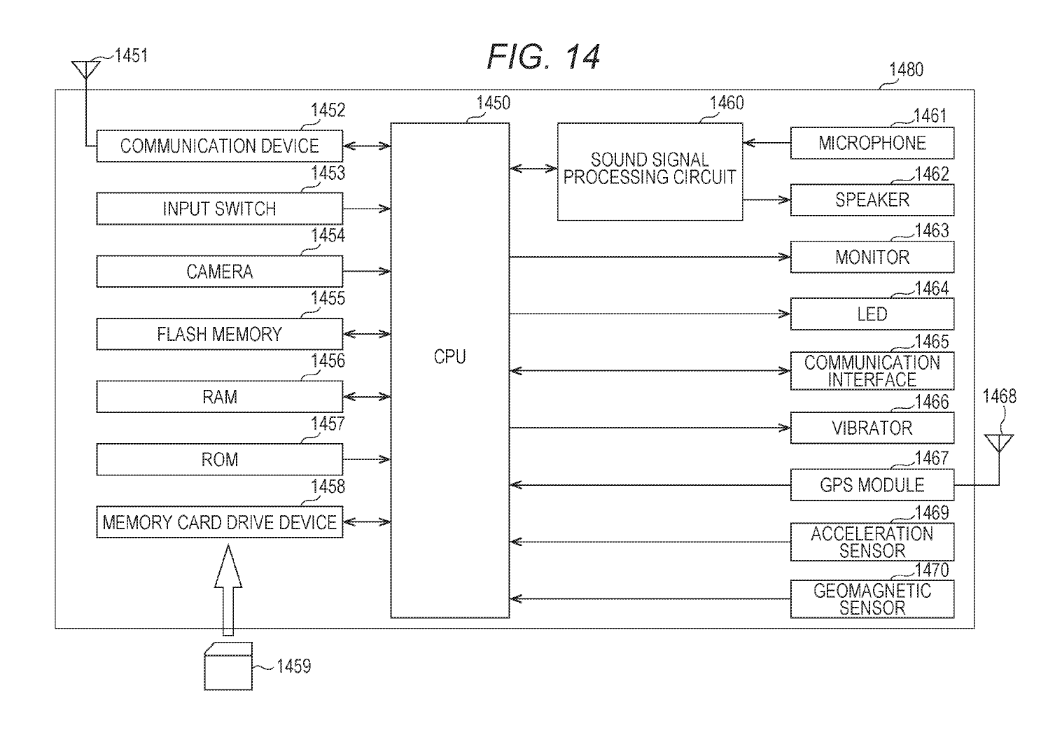

A configuration of the smartphone 1480 is now described with reference to FIG. 14. FIG. 14 is a block diagram for illustrating a hardware configuration of the smartphone 1480. The smartphone 1480 includes a central processing unit (CPU) 1450, an antenna 1451, a communication device 1452, an input switch 1453, a camera 1454, a flash memory 1455, a random access memory (RAM) 1456, a read-only memory (ROM) 1457, a memory card drive device 1458, a microphone 1461, a speaker 1462, a sound signal processing circuit 1460, a monitor 1463, a light emitting diode (LED) 1464, a communication interface 1465, a vibrator 1466, a global positioning system (GPS) antenna 1468, a GPS module 1467, an acceleration sensor 1469, and a geomagnetic sensor 1470. A memory card 1459 may be mounted to the memory card drive device 1458.

The antenna 1451 is configured to receive a signal emitted by a base station, and to transmit a signal for communicating to/from another communication device via the base station. The signal received by the antenna 1451 is subjected to front-end processing by the communication device 1452, and the processed signal is transmitted to the CPU 1450.

The CPU 1450 is configured to execute processing for controlling a motion of the smartphone 1480 based on a command issued to the smartphone 1480. When the smartphone 1480 receives a signal, the CPU 1450 executes processing defined in advance based on a signal transmitted from the communication device 1452, and transmits the processed signal to the sound signal processing circuit 1460. The sound signal processing circuit 1460 is configured to execute signal processing defined in advance on the signal, and to transmit the processed signal to the speaker 1462. The speaker 1462 is configured to output a voice based on that signal.

The input switch 1453 is configured to receive input of a command to the smartphone 1480. The input switch 1453 is implemented by a touch sensor or a button arranged on a body of the smartphone 1480. A signal in accordance with the input command is input to the CPU 1450.

The microphone 1461 is configured to receive sound spoken into the smartphone 1480, and to transmit a signal corresponding to the spoken sound to the sound signal processing circuit 1460. The sound signal processing circuit 1460 executes processing defined in advance in order to perform verbal communication based on that signal, and transmits the processed signal to the CPU 1450. The CPU 1450 converts the signal into data for transmission, and transmits the converted data to the communication device 1452. The communication device 1452 uses that data to generate a signal for transmission, and transmits the signal to the antenna 1451.

The flash memory 1455 is configured to store the data transmitted from the CPU 1450. The CPU 1450 reads out the data stored in the flash memory 1455, and executes processing defined in advance by using that data.

The RAM 1456 is configured to temporarily store data generated by the CPU 1450 based on an operation performed on the input switch 1453. The ROM 1457 is configured to store a program or data for causing the smartphone 1480 to execute an operation determined in advance. The CPU 1450 reads out the program or data from the ROM 1457 to control the operation of the smartphone 1480.

The memory card drive device 1458 is configured to read out data stored in the memory card 1459, and to transmit the read data to the CPU 1450. The memory card drive device 1458 is also configured to write data output by the CPU 1450 in a storage area of the memory card 1459.

The sound signal processing circuit 1460 is configured to execute signal processing for performing verbal communication like that described above. In at least one embodiment, there is illustrated a configuration in which the CPU 1450 and the sound signal processing circuit 1460 are separate is exemplified, but in at least one aspect, the CPU 1450 and the sound signal processing circuit 1460 are integrated.

The monitor 1463 is a touch-operation type monitor. However, the mechanism for receiving the touch operation is not particularly limited. The monitor 1463 is configured to display, based on data acquired from the CPU 1450, an image defined by the data. For example, the monitor 1463 displays a still image, a moving image, a map, and the like stored in the flash memory 1455.

The LED 1464 is configured to emit light based on a signal output from the CPU 1450. The communication interface 1465 is implemented by, for example, Wi-Fi, Bluetooth (trademark), or near field communication (NFC). In at least one aspect, a cable for data communication is mounted to the communication interface 1465. The communication interface 1465 is configured to emit a signal output from the CPU 1450. The communication interface 1465 may also be configured to transmit to the CPU 1450 data included in a signal received from outside the smartphone 1480. In at least one aspect, when the smartphone 1480 is mounted to the HMD 120, the communication interface 1465 is able to communicate to/from the communication interface of the HMD 120.

The vibrator 1466 is configured to execute a vibrating motion at a frequency determined in advance based on a signal output from the CPU 1450.

The GPS antenna 1468 is configured to receive GPS signals transmitted from four or more satellites. Each of the received GPS signals is input to the GPS module 1467. The GPS module 1467 is configured to acquire position information on the smartphone 1480 by using each GPS signal and a known technology to execute positioning processing.

The acceleration sensor 1469 is configured to detect acceleration acting on the smartphone 1480. In at least one aspect, the acceleration sensor 1469 is implemented as a three-axis acceleration sensor. The detected acceleration is input to the CPU 1450. The CPU 1450 detects a movement and a posture (inclination) of the smartphone 1480 based on the input acceleration.

The geomagnetic sensor 1470 is configured to detect the direction in which the smartphone 1480 is facing. Information acquired by the detection is input to the CPU 1450.

There is now described an outline of a specific example of at least one embodiment of this disclosure. A two-dimensional code (e.g., QR code (trademark)) including information for accessing VR content is marked on a good. The good relates to, for example, a character appearing in the VR content. Examples of the good include, but are not limited to, mugs, T-shirts, cards, CD cases, and clear folders. However, there are goods that cannot be marked with a two-dimensional code, and hence a ticket printed with the two-dimensional code may be sold. The good or ticket may be sold in the same way as existing operations in the shop. It is not always required for the good to relate to a character, and the good may be a general product. In this case, as a sales promotion of the good, the two-dimensional code may be marked on the good. For example, there is expected a case in which the two-dimensional code is marked on a cap or body of a plastic beverage bottle.

In the shop, a VR headset is prepared. As one mode of the VR headset, a mode in which a smartphone having a camera is mounted to the HMD is conceivable. The VR headset may photograph the outside of the VR headset when used.

When the user visiting the shop puts on the VR headset, the camera of the smartphone is activated, and an image photographed by the camera, namely, an image in front of the user, is displayed on the HMD monitor (e.g., smartphone monitor). Therefore, in a state in which the user is wearing the HMD, the user is able to view the real world through the photographed image of the camera in a see-through manner.

In a state in which the user is wearing the HMD, when the two-dimensional code is read by the camera, the data on the VR content is distributed by streaming from the server to the computer connected to the HMD. When this data is further transmitted to the smartphone, the monitor begins to display the VR content.

The user knows how to perform the operation of reading the two-dimensional code with the camera of the smartphone, and hence the VR content may be played back without asking the shop staff (without adding an operation for using the VR headset).

During playback of the VR content, an opportunity to take a photograph is provided to the user. When the user is photographing a desired scene, the smartphone stores the two-dimensional code read in order to play back VR content and the photographed image in association with each other. After watching the VR content and the user has removed the smartphone from the HMD, the user is able to browse the photographed images by using a smartphone application or the like.

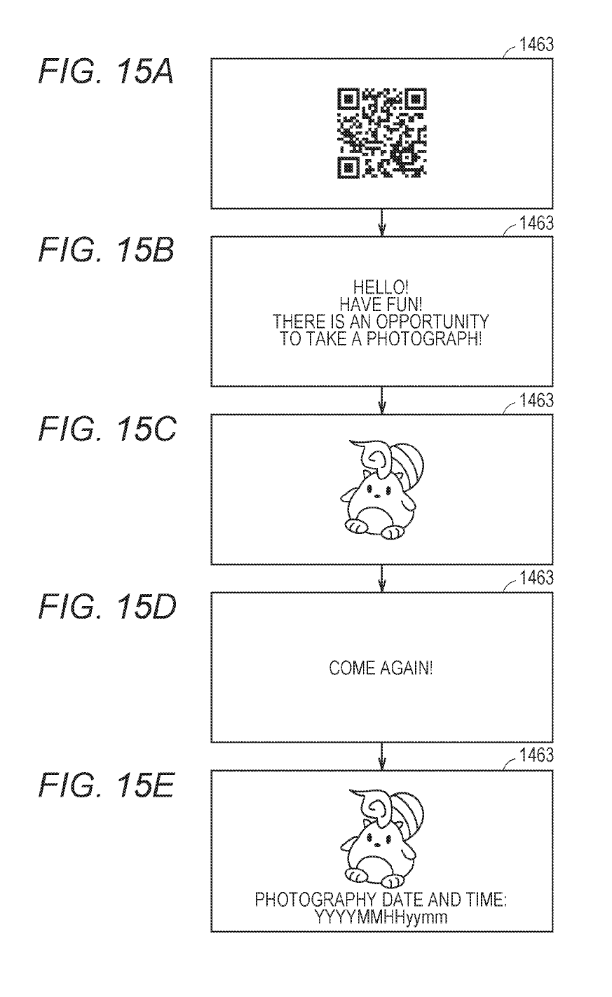

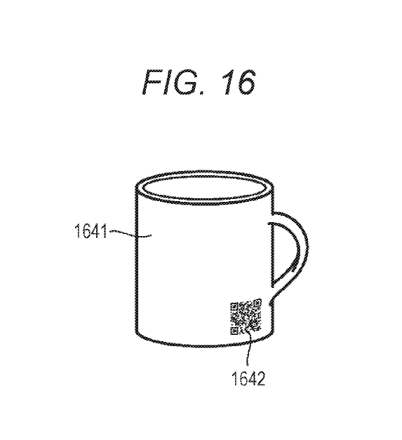

At least one aspect of this disclosure is now described with reference to FIG. 15A to FIG. 15D. FIG. 15A to FIG. 15D are diagrams of transitions of the screen displayed on the monitor 1463 according to at least one embodiment of this disclosure. The monitor 1463 corresponds to, for example, a monitor incorporated in the HMD, a smartphone mounted to the HMD, or a monitor of another information terminal.

In FIG. 15A, in at least one aspect, the monitor 1463 displays a to-be-photographed image of the two-dimensional code. When the access information included in the two-dimensional code is extracted, communication is performed between the terminal to which the monitor 1463 is connected and the management server of the VR content, and the access information is transmitted from the terminal to the management server. The access information includes a content ID, a content authentication number, a validity period, and the like. In order to prevent unauthorized use of the access information and improve the accuracy of authentication, position information on the terminal from which the information has been extracted from the two-dimensional code may be transmitted to the management server. When it is confirmed that the information is valid information, the management server transmits to the terminal a message to be shown before playing back the VR content associated with the two-dimensional code. In FIG. 15B, the monitor 1463 displays the message.

Output of the VR content (e.g., playback of video and output of sound) then starts. For example, in FIG. 15C, the monitor 1463 displays an image of the VR content downloaded based on the two-dimensional code. During the playback of the VR content, the user of the monitor 1463 may photograph the image of the VR content. The photographed image may be stored on the terminal. The location of the content data (e.g., frame number) at which photography was performed is transmitted together with the ID of the user to the server by the terminal. In this case, the server may accumulate user IDs, VR content identification numbers, and frame numbers in the database in association with each other.

In FIG. 15D, when the playback of the VR content finishes, the monitor 1463 displays a message such as “Come again”. Then, in FIG. 15E, the monitor 1463 displays the date and time at which the image was photographed during the playback of the VR content and the image of the VR content photographed at that time.

### First Embodiment

A first embodiment of this disclosure is now described. In the first embodiment, the two-dimensional code marked on the good includes access information. The access information is used to access the VR content.

The HMD system 100 described with reference to FIG. 1 functions as a content providing system that uses an HMD. In at least one aspect, the HMD system 100 is arranged in shops, amusement facilities, and the like. In the first embodiment, the HMD is any one of a so-called head-mounted display having a monitor and a head-mounted device to which a smartphone or other terminals having a monitor may be mounted. There is now mainly described a case in which a smartphone is attachable to and detachable from a head-mounted device.

When the HMD system 100 is used in a shop, the user 5 wearing the HMD 120 is able to visually recognize a mug 1641 sold at the shop as a video displayed on the monitor 1463. A two-dimensional code (e.g., QR code (trademark)) is marked on the mug 1641.

The monitor 1463 is implemented, for example, as a non-transmissive display device. In at least one aspect, the monitor 1463 is arranged in advance in the main body of the HMD 120 so as to be positioned in front of both eyes of the user. Therefore, when the user visually recognizes the three-dimensional image displayed on the monitor 1463, the user is able to be immersed in the virtual space. In at least one embodiment, the virtual space includes, for example, a background, an object operable by the user, and an image of a menu selectable by user. In at least one embodiment, when the HMD 120 is a structure to which a so-called smartphone or other information display terminal is mounted, the monitor 1463 is implemented as a liquid crystal monitor or an organic electroluminescence (EL) monitor included in the information display terminal.

In at least one aspect, the monitor 1463 includes a sub-monitor for displaying an image for the right eye and a sub-monitor for displaying an image for the left eye. In at least one aspect, the monitor 1463 is configured to display the image for the right eye and the image for the left eye in an integrated manner. In this case, the monitor 1463 includes a high-speed shutter. The high-speed shutter operates such that the image for the right eye and the image for the left eye are alternately displayed so that an image is recognized in only one eye.

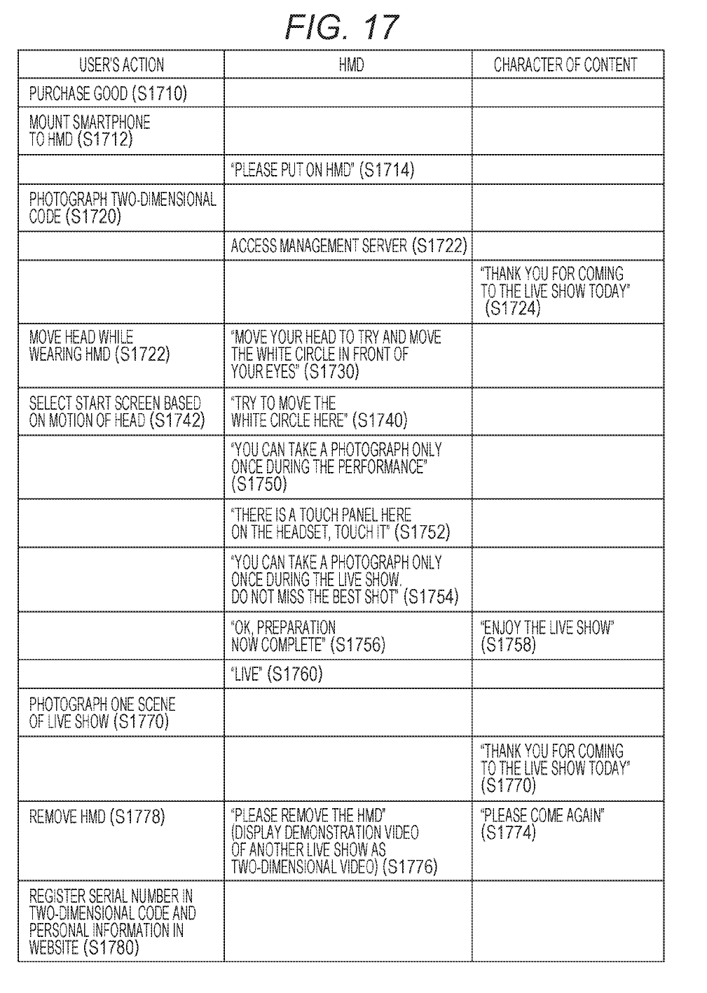

The actions of the user 5, motion of the HMD 120, and the behavior of the character of the VR content are now described with reference to FIG. 17. FIG. 17 is a diagram of motion performed by the HMD 120 when the user 5 enjoys VR content according to the first embodiment of this disclosure.

The user 5 visits a shop and purchases the mug 1641 or another good (Step S1710). Then, the user 5 mounts the smartphone 1480 owned by himself or herself to the HMD 120 (Step S1712). When the user 5 operates the smartphone 1480 in accordance with a procedure determined in advance, an application for receiving the provision of VR content is activated. When execution of the application starts, the HMD 120 displays a message such as “Put on HMD” on the monitor 1463 of the smartphone 1480, or outputs a sound (Step S1714).

The user 5 wearing the HMD 120 activates the camera application of the smartphone 1480, and photographs a two-dimensional code 1642 marked on the purchased good (e.g., mug 1641) (Step S1720).

The HMD 120 accesses the server 600 via the smartphone 1480 and the computer 200 (Step S1722). The smartphone 1480 transmits the image data obtained by photography to the server 600. Then, the VR content is downloaded to the HMD 120 from the server 600.

When the character of the VR content is displayed on the monitor 1463, the monitor 1463 displays a message, for example, “Thank you for coming to the library today” (Step S1724). At this time, a speaker (not shown) included in the HMD 120 may output the message as a sound based on a sound signal output from the smartphone 1480.

The HMD 120 displays a message or outputs a sound, for example, “Move your head to try and move the white circle in front of your eyes” (Step S1730). The user 5 moves his or her head while wearing the HMD 120 on the head (Step S1732). The HMD 120 then displays a message, for example, “Try to move the white circle here”, and outputs a sound (Step S1740). The user 5 moves his or her head on which the HMD 120 is worn, moves the white circle to a predetermined place, and selects the start screen (Step S1742).

When the playback of the VR content starts, the HMD 120 displays a message, for example, “You can take a photograph only once during the performance” (Step S1750). The HMD 120 further displays a message, for example, “There is a touch panel here on the headset, touch it” (Step S1752). The HMD 120 then displays a message, for example, “You can take a photograph only once during the live show. Do not miss the best shot” (Step S1754). Then, the HMD 120 displays a message, for example, “OK, preparation now complete” (StepS1756), and starts playback of the VR content.

When the VR content is displayed on the monitor 1463, the character of the VR content displays a message or outputs a sound, for example, “Enjoy the live show” (Step S1758).

While the VR content is being played back, the HMD 120 displays a message, for example, “LIVE” at, for example, a corner of the screen (Step S1760). During playback of the VR content, the user 5 is able to photograph a live show scene a number of times determined in advance for each piece of VR content (Step S1770). The playback scene may be freely selectable by the user 5 or may be determined in advance. There may also be recommended a scene matching a preference of the user 5. When the playback of the VR content ends, the character of the VR content displays a message, for example, “Thank you for coming to the library today” (Step S1772). The character also displays a message, for example, “Please come again” (Step S1774).

The monitor 1463 of the HMD 120 displays a message or outputs a sound, for example, “Please remove the HMD” (Step S1776). At this time, the HMD 120 may display a demonstration video of a live show of other VR content as a two-dimensional video.

The user 5 removes the HMD 120 from his or her head (Step S1788). The user then registers a serial number displayed when the two-dimensional code is read and personal information on the user in the website providing the VR content (Step S1780). For example, when the user 5 accesses a link destination displayed on the monitor 1463, the serial number and the personal information are transmitted to the server 600.

[Detailed Configuration of Modules]

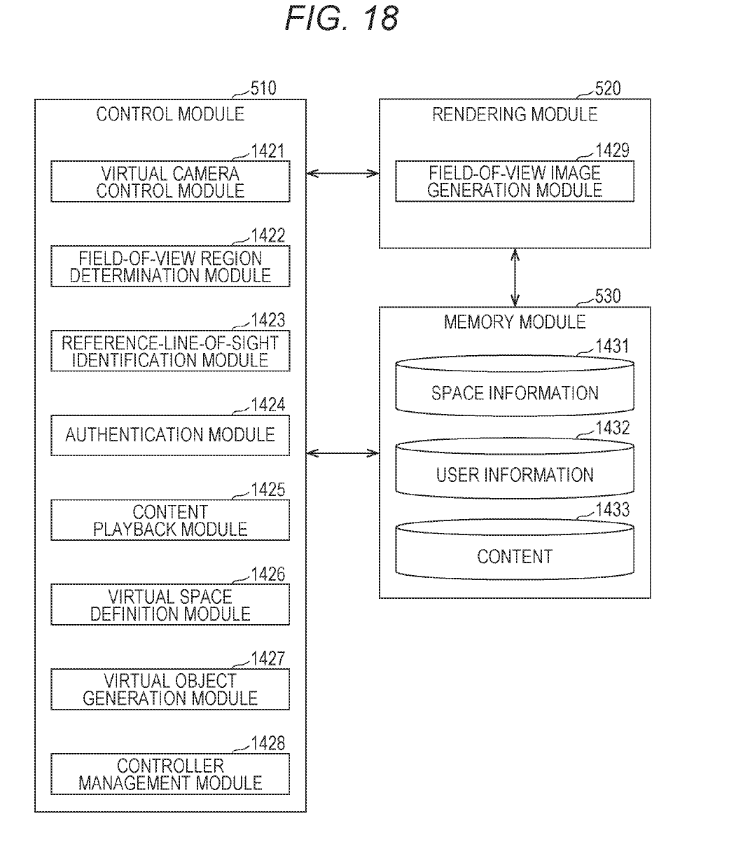

The module configuration of the computer 200 is now described in detail with reference to FIG. 18. FIG. 18 is a block diagram of a detailed configuration of modules of the computer 200 according to at least one embodiment of this disclosure.

In FIG. 18, the control module 510 includes a virtual camera control module 1421, a field-of-view region determination module 1422, a reference-line-of-sight identification module 1423, an authentication module 1424, a content playback module 1425, a virtual space definition module 1426, a virtual object generation module 1427, and a controller management module 1428. The rendering module 520 includes a field-of-view image generation module 1429. The memory module 530 stores space information 1431, user information 1432, and content 1433.

In at least one aspect, the control module 510 controls display of images on the monitor 1463 of the HMD 120. The virtual camera control module 1421 arranges the virtual camera 14 in the virtual space 11, and controls the behavior, the direction, and the like of the virtual camera 14. The field-of-view region determination module 1422 defines the field-of-view region 15 in accordance with the direction of the head of the user wearing the HMD 120. The field-of-view image generation module 1429 generates the field-of-view image 17 to be displayed on the monitor 1463 based on the determined field-of-view region 15.

The reference line-of-sight identification module 1423 identifies the line of sight of the user 5 based on the signal from the eye gaze sensor 140.

The authentication module 1424 determines, based on the data transmitted from the HMD 120 and the data transmitted from the server 600, whether the data transmitted from the HMD 120 is legitimate data registered in advance. In this case, legitimate data is, for example, identification data of moving image content or other VR content prepared in advance.

The content playback module 1425 plays back the content data transmitted from the server 600, and transmits the content data to the HMD 120 as a streaming video.

The control module 510 controls the virtual space 11 provided to the user 5. The virtual space definition module 1426 defines the virtual space 11 in the HMD system 100 by generating virtual space data representing the virtual space 11. The virtual object generation module 1427 may generate a target object to be arranged in the virtual space 11.

The controller management module 1428 receives a motion of the user 5 in the virtual space 11, and controls the controller object in accordance with the motion. The controller object according to at least one embodiment functions as a controller for issuing instructions to the other objects arranged in the virtual space 11. In at least one aspect, the controller management module 1428 generates data for arranging in the virtual space 11 the controller object for receiving control in the virtual space 11. When the HMD 120 receives this data, the monitor 1463 may display the controller object.

The memory module 530 stores data to be used by the computer 200 to provide the virtual space 11 to the user 5. In at least one aspect, the memory module 530 stores the space information 1431, the user information 1432, and the content 1433.

The space information 1431 stores one or more templates defined in order to provide the virtual space 11. The user information 1432 includes the identification information on the user 5 of the HMD 120, an authority associated with the user 5, and the like. The authority includes, for example, account information (user ID and password) and the like for accessing the website providing the application. The content 1433 includes, for example, the VR content presented by the HMD 120.

[Data Structure]

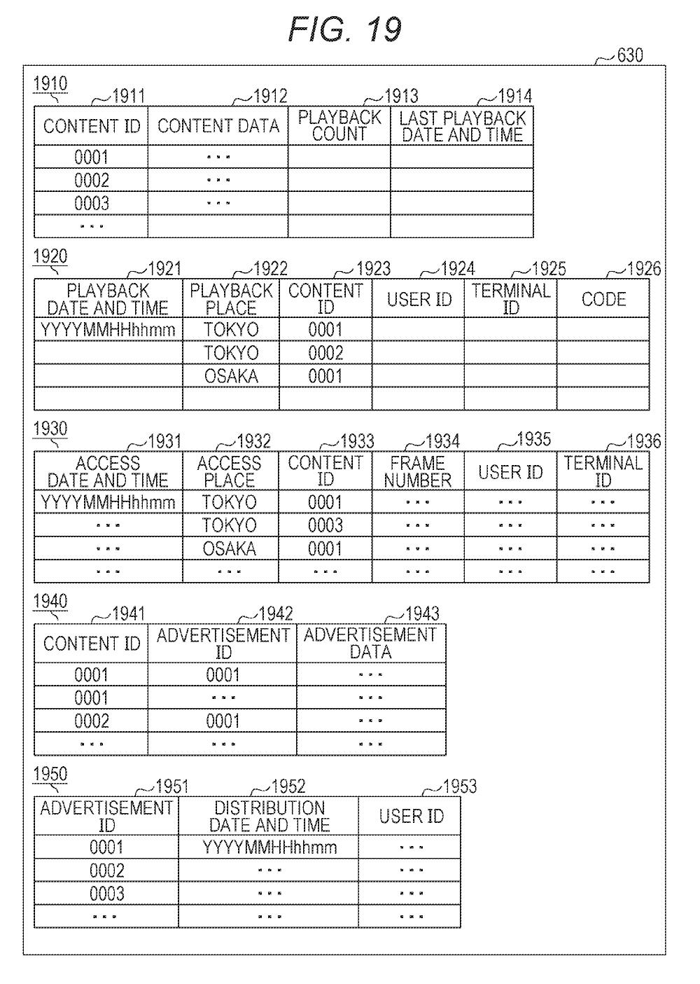

The data structure of the server 600 is now described with reference to FIG. 19. FIG. 19 is a schematic diagram of one mode of storage of data in the storage 630 included in the server 600 according to at least one embodiment of this disclosure. The storage 630 stores tables 1910, 1920, 1930, 1940, and 1950.

The table 1910 includes a content ID 1911, content data 1912, a playback count 1913, and a last playback date and time 1914. The content ID 1911 identifies the VR content to be provided by the HMD 120. The content data 1912 is the data of the VR content. The playback count 1913 indicates the number of times that the VR content has been played back by the HMD 120 of each shop. The last playback date and time 1914 indicates the date and time at which the VR content was last played back.

The table 1920 stores a playback history of the VR content. More specifically, the table 1920 includes a playback date and time 1921, a playback place 1922, a content ID 1923, a user ID 1924, a terminal ID 1925, and a two-dimensional code 1926. The playback date and time 1921 indicates the date and time at which playback of VR content was performed. The playback place 1922 indicates the place in which the VR content was played back (e.g., shop name, address, or coordinate values). The content ID 1923 identifies the VR content. The user ID 1924 identifies the user who viewed the VR content. The terminal ID 1925 identifies the terminal (HMD 120 or smartphone 1480) on which the playback of the VR content was performed.

The table 1930 stores data relating to scenes selected and photographed by the user. For example, when the user logs in to the user screen of the VR content from a personal computer at home and browses the photographed image, a browsing record is stored in the table 1930. More specifically, the table 1930 includes an access date and time 1931, an access place 1932, a content ID 1933, a frame number 1934, a user ID 1935, and a terminal ID 1936. The access date and time 1931 indicates the date and time at which access to the VR content was performed. The access place 1932 indicates the place in which the access to the VR content was performed (e.g., Internet protocol (IP) address, geographical coordinate values, residential address, or other position information on the personal computer at the home of the user 5). The frame number 1934 is the frame number of the VR content data as a moving image, and identifies the photographed image. The user ID 1935 identifies the user who viewed the VR content and acquired the photographed image. The terminal ID 1936 identifies the terminal from which the access was performed (e.g., a personal computer at home).

The table 1940 corresponds to an advertisement database. More specifically, the table 1940 includes a content ID 1941, an advertisement ID 1942, and advertisement data 1943. Like the content ID 1911, the content ID 1941 identifies the VR content. The advertisement ID 1942 identifies an advertisement associated with the VR content. One piece of VR content is associated with one or more advertisements. The advertisement data 1943 indicates the data of the advertisement. Each advertisement may be associated in advance with the VR content.

The table 1950 includes an advertisement ID 1951, a distribution date and time 1952, and a user ID 1953. Like the advertisement ID 1942, the advertisement ID 1951 identifies an advertisement. The distribution date and time 1952 indicates the date and time at which the advertisement identified by the advertisement ID 1951 was distributed. The user ID 1953 indicates the user to whom the advertisement was distributed (presented). For example, when the user 5 browses the photographed image of the VR content by accessing the server 600 from his or her personal computer at home, the advertisement associated with the VR content is displayed on the monitor of the personal computer, and the distribution history at this time is stored in the table 1950.

[VR Content Playback Procedure]

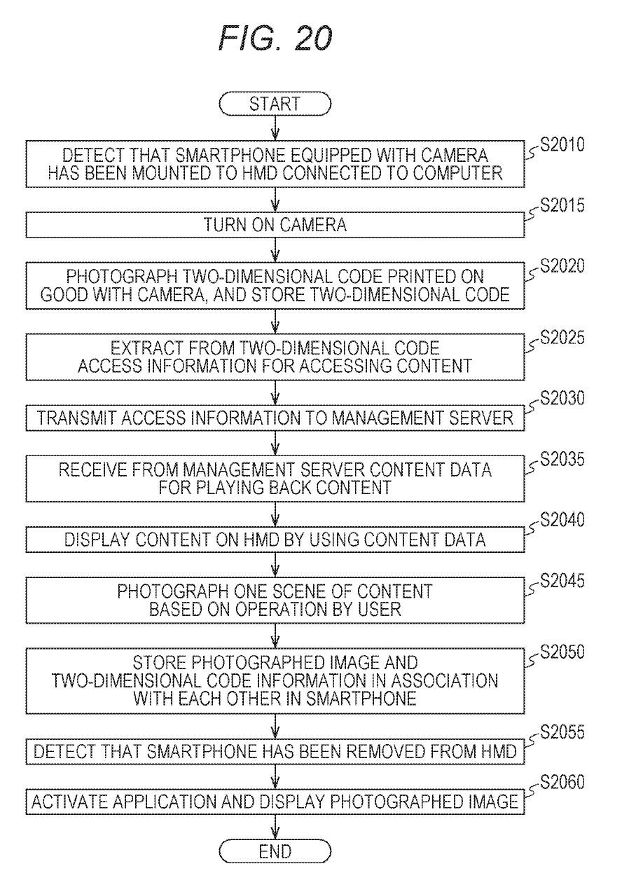

A procedure for playing back VR content is now described with reference to FIG. 20. FIG. 20 is a flowchart of a portion of processing to be executed by the smartphone 1480 mounted to the HMD 120 according to at least one embodiment of this disclosure. This processing is executed when the user 5 mounts the smartphone 1480 on the HMD 120 in a shop and views the VR content.

In Step S2010, the CPU 1450 of the smartphone 1480 detects that the smartphone 1480 has been mounted to the HMD 120 connected to the computer 200. For example, the CPU 1450 detects the mounting by detecting that the interface for charging the smartphone 1480 has been connected to the terminal of the HMD 120.

In Step S2015, the CPU 1450 activates the camera application to turn on the camera 1454.

In Step S2020, the CPU 1450 photographs, based on an operation by the user 5, the two-dimensional code 1642 printed on the good (e.g., mug 1641) with the camera 1454, and stores the image data of the two-dimensional code in the flash memory 1455.

In Step S2025, the CPU 1450 extracts from the two-dimensional code access information for accessing the VR content. The access information is created in advance by the provider or the like of the VR content, and includes, for example, a content ID and a validity period of the VR content. In another aspect, the access information includes position information on the shop or other sales location at which the good is sold. Through use of position information as the authentication target, even if the access information is illegitimately copied, the use of illegitimately acquired access information can be prevented by using the position information to perform authentication.

In Step S2030, the CPU 1450 transmits to the management server (e.g., server 600) of the service providing the VR content the user ID of the smartphone 1480 and the access information via the computer 200. In another aspect, the CPU 1450 transmits position information on the smartphone 1480 (i.e., information for identifying the place from which the access information is acquired). When it is authenticated that the access information is valid information, the server 600 reads out the content data and transmits the content data to the computer 200. The transmission of the content data is performed by, for example, streaming distribution.

In Step S2035, the CPU 1450 receives from the server 600 the content data for playing back the VR content. In Step S2040, the CPU 1450 displays the VR content on the monitor 1463 by using the received content data.

In Step S2045, the CPU 1450 photographs one scene of the VR content on the camera 1454 based on an operation by the user 5. The scene to be photographed is freely determined by the user 5. In at least one aspect, the scene is determined in advance by the provider of VR content. In at least one aspect, the scene is recommended to the user 5 based on the photography history of other users who viewed the same VR content or based on a recommendation degree or other comments input by other users.

In Step S2050, the CPU 1450 stores the photographed image and the two-dimensional code information in association with each other in the flash memory 1455. In at least one aspect, the stored data is temporarily stored in the smartphone 1480, and information identifying the photographed scene and the two-dimensional code information are transmitted from the computer 200 to the server 600. The server 600 manages the data received from the computer 200, and at a later date, in accordance with a request by the user 5, transmits the data of the photographed image to the terminal (e.g., smartphone 1480 or personal computer at home) used by the user 5. At this time, the server 600 may further transmit, for example, advertisement data or promotion information associated with the VR content. As a result, information matching a preference of the user 5 may be provided to the user 5. In Step S2055, the CPU 1450 detects that the smartphone 1480 has been removed from the HMD 120.

In Step S2060, the CPU 1450 activates, based on an operation by the user 5, the photograph application and displays the photographed image on the monitor 1463. This display may be any one of display using image data stored in a nonvolatile manner in the smartphone 1480 and display using data temporarily stored in the RAM 1456. In at least one aspect, the user 5 inputs a comment while looking at the image. The input comment is transmitted from the terminal displaying the image to the server 600. The server 600 stores the comment in association with the VR content. When another user views the same VR content as that VR content, the comment may be provided to the another user. In this way, the provider of the VR content accumulates data indicating the preference of each user, which enables an advertisement matching the preference of the users to be provided to the users browsing the VR content or the image.

[Photographed Image Playback Processing]

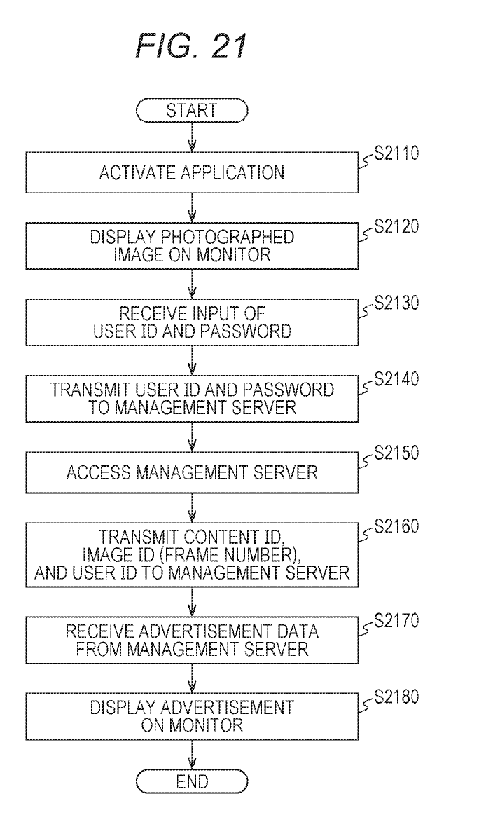

A control structure of the smartphone 1480 is now described with reference to FIG. 21. FIG. 21 is a flowchart of an example of a portion of processing to be executed by the smartphone 1480 to display an image photographed during playback of the VR content according to the first embodiment of this disclosure. This processing is executed, for example, when the user 5 operates the smartphone 1480 at a place other than a shop, for example, at home or on a train.

In Step S2110, the CPU 1450 activates an application for displaying a photograph based on an operation by the user 5.

In Step S2120, the CPU 1450 displays, based on a touch operation for selection by the user 5, on the monitor 1463 an image photographed when the user 5 viewed the VR content in the shop. Information associated with the image, such as the content ID, an image ID, and other attribute information is also loaded into the RAM 1456.

In Step S2130, the CPU 1450 receives input of the user ID and the password based on a touch operation by the user 5 on the monitor 1463.

In Step S2140, the CPU 1450 transmits the user ID and the password to the management server (e.g., server 600). In Step S2150, the CPU 1450 accesses the management server and establishes communication. In Step S2160, the CPU 1450 transmits the content ID, the image ID (frame number), and the user ID to the management server.

In Step S2170, the CPU 1450 receives advertisement data from the management server. In Step S2180, the CPU 1450 displays an advertisement on the monitor 1463 based on the received advertisement data. When a comment by another user who has photographed the image is registered in the server 600, the server 600 may also transmit the comment to the smartphone 1480. In this case, the CPU 1450 displays the comment by the another user on the monitor 1463, and hence the user 5 is able to know the impression of the another user on the image.

[Screen Display Mode]

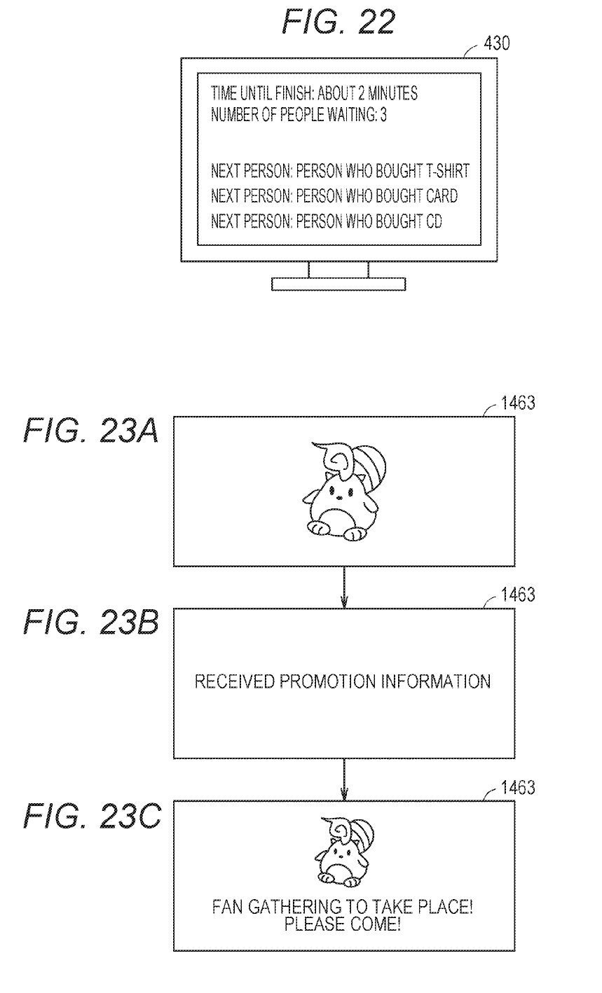

A screen display mode of at least one embodiment is now described with reference to FIG. 22 and FIG. 23A to FIG. 23C. FIG. 22 is a diagram of a screen displayed on a display 430 installed in a shop according to the first embodiment of this disclosure. FIG. 23A to FIG. 23C are diagrams of transitions of the screen on the monitor 1463 of the smartphone 1480 according to the first embodiment of this disclosure.

In FIG. 22, the display 430 displays a screen for showing a waiting situation for users other than the user 5. This screen is displayed, for example, when the user 5 puts on the HMD 120 and views VR content by using the smartphone 1480 fitted in the HMD 120. More specifically, the display 430 displays, as a waiting situation, the time until playback of the VR content by the user 5 finishes and the number of users waiting for their turn (number of people waiting). The display 430 also displays information indicating who the next user is. For example, the two-dimensional code is marked on various goods (e.g., mugs, T-shirts, cards, CDs, and bags), and hence the display 430 may display the purchaser of a good based on identification data of the good included in the two-dimensional code. In at least one aspect, the display 430 displays the ID of user registered as the user to receive playback of the VR content.

(Summary)

As described above, in the first embodiment, it is possible to easily provide a virtual reality space to many users. In the first embodiment, each user is able to enjoy VR content by using a smartphone or another terminal owned by himself or herself, and is able to photograph a desired scene. As a result, after enjoyably viewing the VR content, the users are able to enjoy a photographed image.

In at least one aspect, the VR content that is played back after reading the two-dimensional code is determined randomly, for example, by a lottery, regardless of the information included in the two-dimensional code. As an example, when the two-dimensional code is read, one of 20 kinds of VR content may be selected as a playback target by lottery, for example. In this case, VR content in which a plurality of characters appear has a higher rarity than that of VR content in which only one character appears. Therefore, a playback frequency of VR content in which a plurality of characters appear may be set to a lower value than that of the playback frequency of VR content in which only one character appears.

In at least one aspect, when another user is waiting for playback of the VR content, during the waiting time, the computer 200 transmits a message determined in advance to the user by using the sound of a character that the another user is presumed to like. In this way, the feeling of expectation of the another user may be increased during the waiting time.

In at least one aspect, the viewed VR content, the user who viewed the VR content, and the photographed scene are stored in the server 600 in association with each other. The VR content and the scene are associated in advance with an advertisement. The server 600 may provide the advertisement to the user based on the VR content or the photographed scene, and hence there is an increased possibility that the server 600 provides an advertisement matching the preference of the user.

In the first embodiment described above, the VR content is identified based on information included in the two-dimensional code. In at least one aspect, the VR content is randomly output. For example, the information included in the two-dimensional code is used as a trigger for the server 600 to randomly extract the VR content. When the VR content is randomly output, the user 5 does not know the content until he or she visually recognizes the JR content that is played back, which may increase his or her interest in the VR content.

In at least one aspect, the avatar of the user 5 is added when photographing one scene of the VR content. For example, a combined image may be formed by adding the avatar object of the user 5 to a place determined in advance when the user 5 has performed photography.

### Second Embodiment

A second embodiment of disclosure is now described. In the second embodiment, access information marked on a card, a ticket, or other medium is used to access VR content.

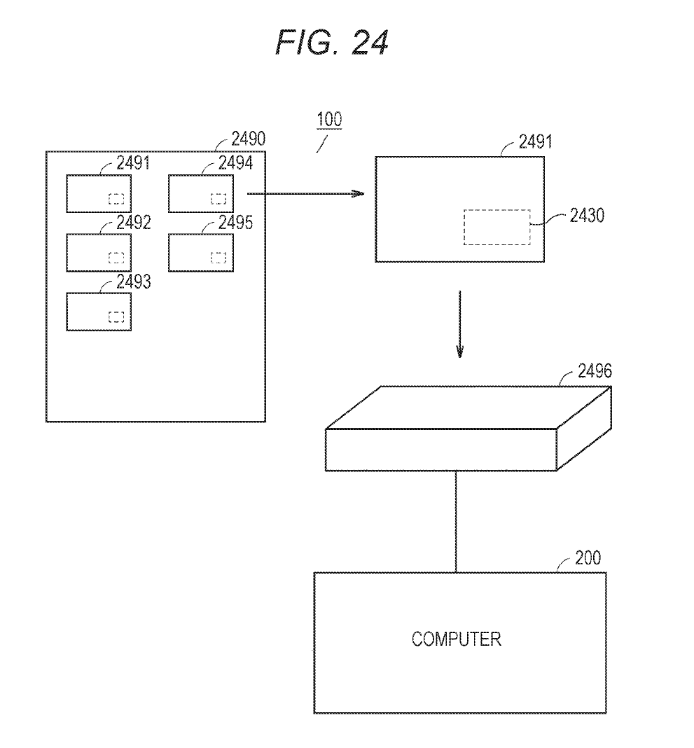

Provision of the VR content in the second embodiment is now described with reference to FIG. 24. FIG. 24 is a schematic diagram of a configuration of the HMD system 100 according to the second embodiment of this disclosure. The HMD system 100 includes a ticket shelf 2410, a card reader 2420, a computer 200, an HMD 120, and a display 430. The HMD 120 and the display 430 are the same as in the first embodiment, and hence a description of those parts is omitted here. The HMD system 100 is arranged in, for example, an anime (Japanese animation) shop, a character shop, a convenience store, and other shops. Similarly to the first embodiment, the HMD system 100 is connected to the server 600 via the network 2.

Tickets 2411 to 2415 for viewing the VR content to be provided are displayed on the ticket shelf 2410. Each card includes an IC chip 2430. The IC chip 2430 stores access information. When the user 5 purchases a card, the user 5 holds the card over the card reader 2420 and executes an activation process. The data read out from the IC chip 2430 contains a ticket ID, a content authentication number, and other access information. The read out data is input to the computer 200. The computer 200 transmits the input data to the server 600, and authenticates whether the card is a legitimate card. When the cart is authenticated as being a legitimate card, the server 600 transmits the data of the VR content identified on the card to the computer 200. The computer 200 transmits the received data to the HMD 120. The smartphone 1480 connected to the HMD 120 displays the VR content based on the data.

[Data Structure]

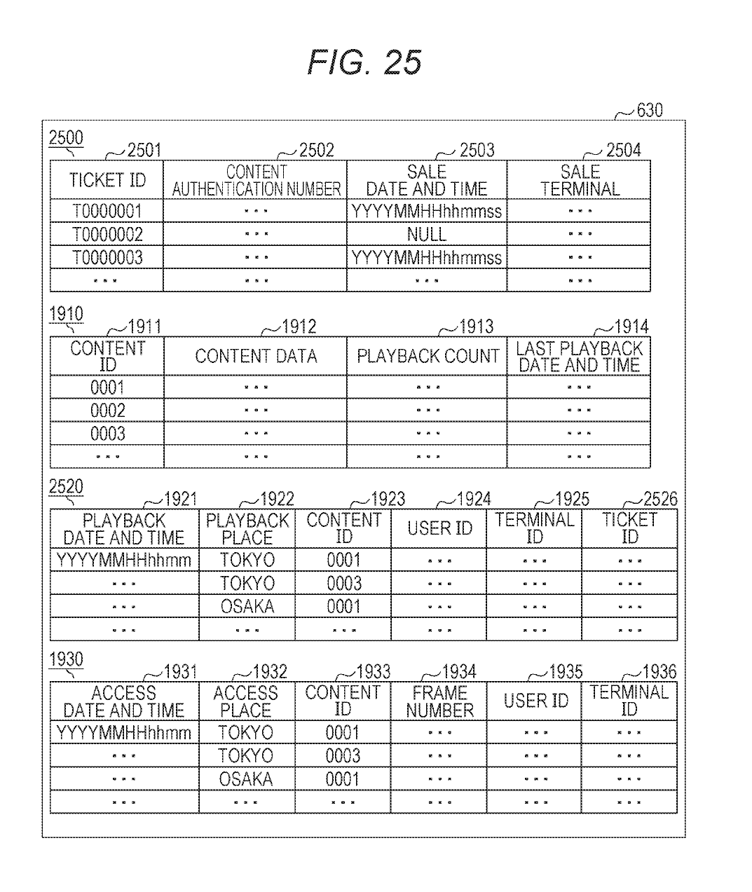

A data structure of the server 600 according to the second embodiment of this disclosure is now described with reference to FIG. 25. FIG. 25 is a diagram of one mode of storage of data in the storage 630 included in the server 600 according to the second embodiment of this disclosure. The storage 630 includes a table 2500, a table 1910, a table 2520, and a table 1930.

The table 2500 includes a ticket ID 2501, a content authentication number 2502, a sale date and time 2503, and a sales terminal 2504. The ticket ID 2501 identifies the tickets sold at each shop. The content authentication number 2502 controls access to the VR content that may be played back by the ticket. For example, when the content authentication number transmitted from the computer 200 matches the content authentication number 2502, the CPU 1450 determines that the ticket identified by the content authentication number and the ticket ID is valid. The sale date and time 2503 indicates the date and time when the ticket is sold. For example, the time at which the ticket is read by the card reader 2420 is stored in the table 2500 as the sale date and time 2503. The sales terminal 2504 indicates the device used at the place where the ticket is sold. For example, the sales terminal 2504 identifies a point of sales (POS) system or the card reader 2420 arranged in the shop, or the computer 200.

The table 1910 includes a content ID 1911, content data 1912, a playback count 1913, and a last playback date and time 1914 similarly to the first embodiment described above.

The table 2520 includes a playback date and time 1921, a playback place 1922, a content ID 1923, a user ID 1924, a terminal ID 1925, and a ticket ID 2526. The ticket ID 2526 identifies tickets that have been authenticated to view the VR content and determined to be a legitimate ticket.

The table 1930 includes an access date and time 1931, an access place 1932, a content ID 1933, a frame number 1934, a user ID 1935, and a terminal ID 1936.

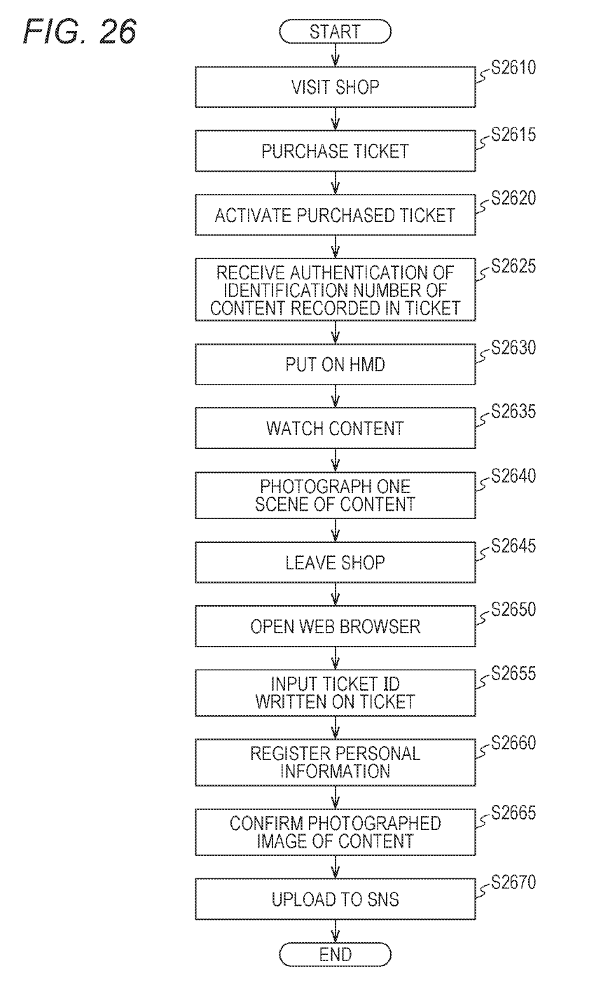

A procedure for viewing VR content in the second embodiment is now described with reference to FIG. 26. FIG. 26 is a flowchart of a flow of procedures to be executed by the user 5 according to the second embodiment of this disclosure.

In Step S2610, the user 5 visits an anime shop, a character shop, or another shop. In Step S2615, the user 5 purchases a ticket 2411 at the shop for viewing VR content. In Step S2620, the user 5 activates the purchased ticket 2411. For example, the ticket 2411 is activated by the staff of the shop using a terminal.

In Step S2625, the user 5 holds the activated ticket 2411 over the card reader 2420, and receives authentication of the identification number of the VR content recorded on the ticket 2411. More specifically, the computer 200 to which the card reader 2420 is connected transmits to the server 600 information (e.g., ticket ID and content authentication number) read from the ticket 2411. The server 600 compares the ticket ID 2501 and the content authentication number 2502 stored in the table 2500 of the storage 630 with the ticket ID and the content authentication number received from the computer 200, and determines whether the ticket is a legitimate ticket.

In Step S2630, the user 5 mounts the smartphone 1480 to the HMD 120, and puts the HMD 120 on his or her head. When the purchased ticket is a legitimate ticket, the server 600 transmits the VR content data to the HMD 120, and the smartphone 1480 displays the VR content based on the data.

In Step S2635, the user 5 experiences the VR content displayed on the monitor 1463 of the smartphone 1480. In at least one aspect, in addition to viewing the VR content, the user 5 is able to participate in the VR content as an avatar object.

In Step S2640, the user 5 photographs one scene of the VR content by operating the controller 300 or by moving his or her line of sight to depressing the photograph button.

In Step S2645, when the user 5 finishes viewing the VR content, the user 5 removes the smartphone 1480 from the HMD 120, and leaves the shop. In Step S2650, the user 5 browses the website of the service providing the VR content by using the smartphone 1480 or a personal computer at home. In Step S2655, the user 5 inputs an identification code and the user ID written on the purchased ticket 2411 into the website and accesses the website.

In Step S2660, the user 5 registers personal information (e.g., address, name, telephone number, e-mail address, and preferences of the user selected from list determined in advance) in the user account of the website. When the server 600 detects that the personal information is registered, the server 600 reads out from the storage 630 to the memory 620 the data photographed when the user was viewing the VR content, and transmits the image data to the terminal (e.g., smartphone 1480 or personal computer) the user 5 is using.

In Step S2665, the user 5 confirms the image photographed when the user 5 was experiencing the VR content.

In Step S2670, the user 5 uploads the photographed image to a user account registered in a social network service (SNS). Other users may enjoy the image photographed by the user 5 by accessing a public page of the user account. When there is a comment regarding the photographed image by the user 5, the comment may also be displayed.

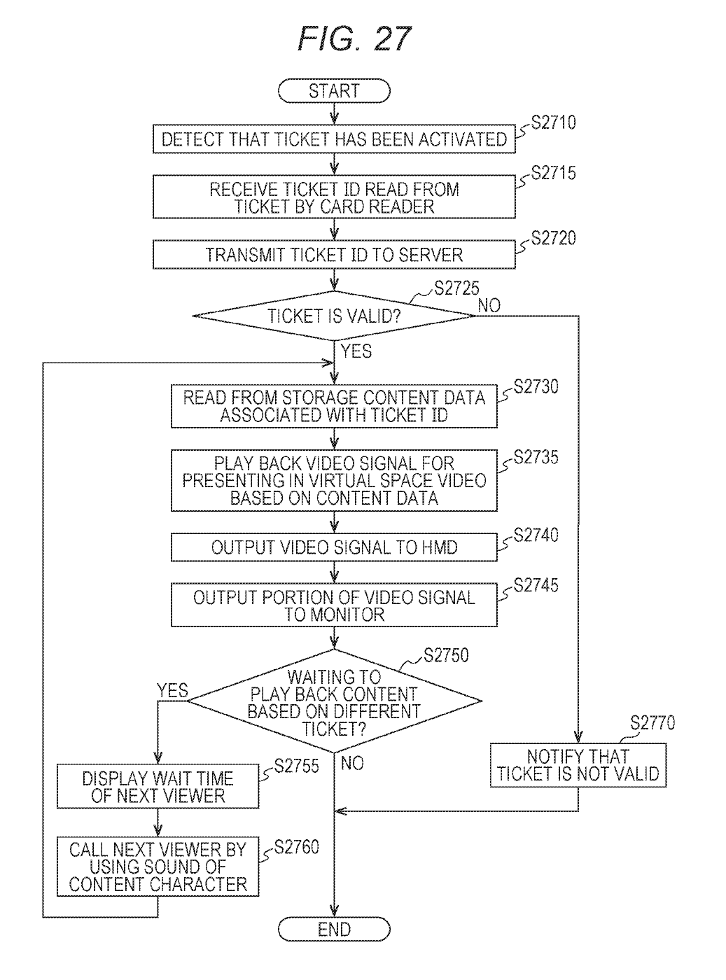

A control structure of the HMD system 100 according to the second embodiment is now described with reference to FIG. 27. FIG. 27 is a flowchart of a portion of processing to be executed by the HMD system 100 according to the second embodiment of this disclosure. This processing is executed by the server 600 or the computer 200.

In Step S2710, the processor 210 of the computer 200 detects, based on a signal from the POS terminal or another terminal, that the purchased ticket has been activated. In Step S2715, the processor 210 receives from the card reader 2420 the identification code read by the card reader 2420. In Step S27120, the processor 210 transmits the received identification code to the server 600.

In Step S2725, the processor 610 of the server 600 executes authentication processing, and determines whether the ticket 2411 is a legitimate ticket. For example, the processor 610 determines whether the ticket 2411 is valid based on a comparison between the ticket ID 2501 and the content authentication number 2502 registered in advance in the storage 630 and the ticket ID and the content authentication number received from the computer 200. When it is determined that the ticket 2411 is valid (YES in Step S2725), the processor 610 switches the control to Step S2730. Otherwise (NO in Step S2725), the processor 610 switches the control to Step S2770.

In Step S2730, the processor 610 reads out the content data associated with the ticket ID from the storage 630, and transmits the content data to the computer 200.

In Step S2735, the processor 210 of the computer 200 generates a video signal for presenting in the virtual space a video based on the content data. In another aspect, the CPU 1450 of the smartphone 1480 may generate the video signal. In Step S2740, the processor 210 outputs the generated video signal to the HMD 120. The video signal is input to the smartphone 1480 mounted to the HMD 120.

In Step S2745, the CPU 1450 of the smartphone 1480 outputs a portion of the video signal to the monitor 1463. The monitor 1463 displays an image of the VR content based on the video signal. The user 5 wearing the HMD in which the smartphone 1480 is fitted is able to view the VR content by visually recognizing the image.

In Step S2750, the processor 210 of the computer 200 determines, based on the presence or absence of a signal from the card reader 2420, whether there is waiting to play back VR content based on a different ticket. When it is determined that there is waiting to play back of VR content (YES in Step S2750), the processor 210 switches the control to Step S2755. Otherwise (NO in Step S2750), the processor 210 ends the processing. In Step S2′755, the processor 210 displays the wait time of the next viewer on the monitor 1463. In Step S2760, the processor 210 calls the next viewer by outputting the sound of the character of the VR content from a speaker (not shown).

In Step S2770, the processor 610 of the server 600 notifies the computer 200 that the ticket is not valid. When this notification is received, the computer 200 may display on the display 430 a message indicating that the ticket is not valid.

[Screen Display Mode]

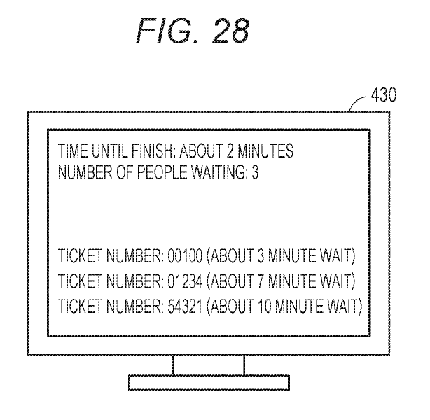

A display mode of the screen in the content providing system according to the second embodiment is now described with reference to FIG. 28. FIG. 28 is a diagram of one mode of the screen displayed by the display 430 for notifying of awaiting order situation according to the second embodiment of this disclosure.

In FIG. 28, the display 430 displays a screen for showing a waiting situation for users other than the user 5. This screen is displayed, for example, when the user 5 puts on the HMD 120 and views VR content by using the smartphone 1480 fitted in the HMD 120. More specifically, the display 430 displays, as a waiting situation, the time (“about two minutes”) until playback of the VR content by the user 5 finishes and the number of users waiting for their turn (“3”). The display 430 also displays information indicating who the next user is. For example, the display 430 displays the ticket number marked on the ticket purchased by each user. In at least one aspect, the display 430 displays a user ID registered as a user who is to receive playback of the VR content, or a title or character of the VR content to be played back.

In at least one aspect, there is employed a mode in which the ticket and the two-dimensional code are used in combination. For example, when the user 5 purchases a ticket by making a request to the staff of the shop, serial numbers are marked on the tickets in advance, and the two-dimensional code includes any one of the serial numbers marked on the tickets as access information.

In this way, during content viewing, when the card reader 2420 reads out the information on the serial number, it is possible to present to a user who is in the waiting order how many users have viewed the content. Through including, in addition to serial number information, information (ticket ID) for identifying the ticket in the two-dimensional code or the IC chip 2430, when the user 5 browses the photographed image with the smartphone 1480 after viewing the VR content, information on the user 5 (e.g., login information for SND account) and information for identifying the ticket are recorded.

When the user 5 again purchases a ticket, views the VR content, and photographs the VR content, the user 5 again performs the login operation for the application and the like and the operation for viewing the photographed image. As a result of those operations, the information for identifying the ticket and the information on the user 5 are associated with the VR content or the photographed image.

Though accumulation of such information in the server 600, the content provider is able to know which images are particularly preferred among the photographed images in understanding of the behavior of each user. For example, it may be assumed that, among the photographed images, a photographed image that has been browsed a large number of times by the user matches the preference of the user. More specifically, for example, when a photographed image of a certain character has been browsed more times than the photographed images of other characters, it may be assumed that the user prefers the certain character.

The technical features disclosed above are summarized as follows.

(Configuration 1)

There is provided a content providing method to be executed by a computer 200 in order to provide content by using an HMD 120. The content providing method includes receiving input of access information (e.g., content ID, ticket ID, and content authentication number) (e.g., content ID, ticket ID, and content authentication number) for accessing content via an interface of the computer 200. The content providing method further includes transmitting the access information to a server 600 for managing one or more pieces of content. The content providing method further includes receiving content data for displaying content from the server 600. The content providing method further includes defining a virtual space 11 for presenting content by using the HMD 120. The content providing method further includes causing the HMD 120 to play back the content by using the content data.

(Configuration 2)

In the content provision method according to Configuration 1, the HMD 120 includes a camera. The receiving of the input of the access information includes photographing a code (e.g., two-dimensional code) including access information by using a camera, receiving input of an image signal obtained by the photographing, and extracting the access information from the image signal.

(Configuration 3)

In the content provision method according to Configuration 1, the receiving of the input of the access information includes acquiring access information from a medium (e.g., tickets 2411 to 2415) on which the access information is recorded.

(Configuration 4)

It is preferred that the content provision method further include displaying the content being played back on the HMD 120 on a display 430 connected to the computer 200.

(Configuration 5)

It is preferred that the content provision method further include displaying a waiting order situation of use of the HMD 120 on the display 430 connected to the computer 200.

(Configuration 6)

It is preferred that the content provision method further include outputting advertisement information associated with content.

(Configuration 7)

It is preferred that the content provision method further include presenting an avatar object corresponding to a user 5 of the HMD 120 together with the content.

(Configuration 8)

It is preferred that the content provision method further include photographing the content being played back.

(Configuration 9)

It is preferred that the content provision method further include displaying an image acquired by the photography.

(Configuration 10)

It is preferred that the content provision method further include displaying a user 5 interface for receiving input of a comment regarding the image acquired by the photography.

(Configuration 11)

It is preferred that the content provision method further include outputting a sound of a character included in a next piece of content to be played back after playback of the content finishes, to thereby prompt a viewer of the next piece of content to put on the HMD 120.

(Configuration 12)

It is preferred that the content provision method further include transmitting to the server 600 position information indicating a place at which playback of the content is performed and identification data associated with the position information.

It is to be understood that the embodiments disclosed herein are merely examples in all aspects and in no way intended to limit this disclosure. The scope of this disclosure is defined by the appended claims and not by the above descriptions, and it is intended that all modifications made within the scope and spirit equivalent to those of the appended claims are duly included in this disclosure.

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted on the target object based on motion of the hand of the user.

What is claimed is:

1. A method of providing content, comprising:
acquiring first information from an article,
wherein the first information identifies first content data to be managed by a server;
acquiring second information from the article,
wherein the second information is used for authentication that an access request to the first content data is valid;
transmitting the access request comprising the first information and the second information to the server;
receiving the first content data from the server,
wherein the first content data is transmitted from the server in response to the server authenticating that the access request is valid by using the second information; and
outputting to a head-mounted device (HMD) a visual-field image that is based on the first content data.

2. The method according to claim 1,
wherein the article comprises a code including the first information and the second information,
wherein the HMD comprises a camera, and
wherein the method further comprises:
using the camera to acquire an image signal by photographing the code;
identifying the code in response to analyzing the image signal; and
acquiring the first information and the second information included in the code in response to the identification of the code.

3. The method according to claim 2,
wherein the camera is configured to photograph outside of the HMD when the user is wearing the HMD, and to output a photographed image to the HMD, and
wherein the method further comprises:
detecting that the user is wearing the HMD;
activating the camera in response to the detection; and
transmitting an access request automatically to the server in response to acquisition of the first information and the second information.

4. The method according to claim 1,
wherein the article comprises a recording medium including the first information and the second information,
wherein the HMD is connected to a communication interface configured to communicate by short-range communication to/from the recording medium, and
wherein the method further comprises:
performing the communication to/from the recording medium via the communication interface; and
acquiring the first information and the second information from the recording medium.

5. The method according to claim 1,
wherein the HMD is connected to an external monitor different from the HMD, and
wherein the method further comprises outputting the first content data to the external monitor in response to the output of the first content data to the HMD.

6. The method according to claim 1,
wherein the HMD is connected to an external monitor different from the HMD,
wherein the HMD is configured to be used by a plurality of users in order, and
wherein the method further comprises:
managing, by the server, a reception history of the access request to a plurality of pieces of content data managed by the server;
updating, by the server, in response to receiving the access request, a list of content data to be output to the HMD;
acquiring third information,
wherein the third information is information on a number of pieces of content data waiting to be output by the HMD and is information generated based on the list;
generating a first sub-image corresponding to the third information; and
outputting the first sub-image to the external monitor.

7. The method according to claim 1,
wherein the HMD is connected to an external monitor different from the HMD,
wherein the HMD is configured to be used by a plurality of users in order, and
wherein the method further comprises:
managing, by the server, a reception history of the access request to a plurality of pieces of content data managed by the server;
updating, by the server, in response to receiving the access request, a list of content data to be output to the HMD;
acquiring fourth information,
wherein the fourth information is information for identifying content data waiting to be played back by the HMD and is information generated based on the list;
generating a second sub-image corresponding to the fourth information; and
outputting the second sub-image to the external monitor.

8. The method according to claim 1, further comprising:
identifying a character associated with the first content data;
identifying an advertisement associated with the character;
identifying a second sub-image corresponding to the advertisement; and
outputting the first content data including the second sub-image to the HMD.

9. The method according to claim 1, further comprising:
identifying an avatar object corresponding to a user associated with the HMD;
defining a virtual space based on the first content data and the avatar object; and
outputting an image that is based on the virtual space to the head-mounted device (HMD).

10. The method according to claim 1, further comprising:
defining a virtual space based on the first content data;
receiving a first input by a user associated with the HMD;
defining a visual field in the virtual space in response to the reception of the first input operation;
identifying a playback time of the content data at a timing at which the first input operation is received; and
generating a photographed image corresponding to the playback time and the visual field.

11. The method according to claim 10,
wherein the HMD is connected to an external monitor different from the HMD, and
wherein the method further comprises outputting the photographed image to the external monitor.

12. The method according to claim 10, further comprising:
outputting the photographed image to the server;
acquiring fifth information,
wherein the fifth information is information on an access destination for downloading the photographed image stored on the server;
transmitting the fifth information to a device of the user;
receiving, by the device of the user, the fifth information;
receiving access from the device of the user to the server based on the fifth information; and
enabling, by the server, the photographed image to be downloaded to the device of the user, in response to the access.

13. The method according to claim 10, further comprising:
receiving a second input by the user for the photographed image, wherein the second input comprises evaluation information; and
associating the evaluation information with the photographed image.

14. The method according to claim 13, further comprising:
identifying content data associated with the photographed image;
storing the evaluation information in the server in association with the content data; and
generating, in response to the association of the evaluation information with the content data, data indicating an accumulation state of the evaluation information associated with the content data.

15. The method according to claim 1,
wherein the HMD is configured to be used by a plurality of users in order,
wherein the HMD is connected to an external speaker different from the HMD,
wherein the server is configured to manage a reception history of the access request to a plurality of pieces of content data managed by the server,
wherein the server is configured to update, in response to the reception of the access request, a list of content data to be output to the HMD, and
wherein the method further comprises:
identifying the second content data to be output to the HMD next after the first content data;
identifying a character associated with the second content data;
identifying a sound associated with the character, wherein the sound comprises a message prompting wearing of the HMD; and
outputting the sound from the external speaker.

16. The method according to claim 1,
wherein the server is configured to manage a reception history of the access request to a plurality of pieces of content data managed by the server,
wherein the second information comprises shop information,
wherein the server is configured to store shop management information, and
wherein the method further comprises:
authenticating, by the server, that the access request is valid based on the shop information and the shop management information; and
storing, by the server, for each shop of the shop information, identification information on content data and an output history of the content data in association with each other.
